(19) United States
(12) Patent Application Publication
(10) Pub. No.: US 2004/0189613 A1
(43) Pub. Date: Sep. 30, 2004

(54) Portable remote pc pad

(76) Inventors: Petra Bauersachs, Ochtendung (DE); Guido Ciburski, Ochtendung (DE)

Correspondence Address: Robert W Becker & Associates, Suite B, 707 Highway 66 East, Tijeras, NM, 87059, US

(21) Appl. No.: 10/486,850

(22) PCT Filed: Jul. 27, 2002
(86) PCT No.: PCT/EP02/08401

(30) Foreign Application Priority Data
Aug. 17, 2001 (DE) 201 13 132.3

(51) Int. Cl. G09G 5/00

(52) U.S. Cl. 345/173

(57) ABSTRACT

The invention relates to a portable remote PC pad for personal computers. It comprises at least two partial devices. One device is connected to the PC and the other can be operated in a mobile manner as a pad within a circumference of 50 metres (in house) or 300 metres outdoors. Wireless radio communication occurs between the devices, including audio/video transmission of the video output card of the PC to the touchscreen video input of the pad. All programs on the PC and screen outputs via the AV channel can be seen on the pad. The software used should be compatible with industrial norms, modularly interchangeable and retrofittable. PC data should be able to be used in a continuously seamless manner without duplication in order to avoid redundancy errors. PC knowledge should remain re-useable and no adaptation should be required in order to work with new systems.

The invention relates to a portable remote PC pad for a personal computer.

Two types of web-pads are known. The first class of known Web pads, such as, for example, a Siemens T-sinus pad, is limited to the remote-transfer of Internet signals and requires as hardware in the pad a complete computer. These mainly have loaded operating systems and software not compatible with PCs and must be maintained as stand-alone systems. The life cycle is correspondingly short, as these systems are subjected to the life cycle of a set top box, and the respective operating system of such is subject to rapid obsolescence. Full PC functionality is missing mainly due to the reason of the limited hardware. Such arrangements are, generally speaking, a mobile set top box provided with a touch screen. Typically, only a browser is offered as the software as well as email-client and display software for several Internet formats, such as audio/video.

The second class of such Web pads such as, for example, Scribor, do not relay the Internet signals but, rather, operate with an intermediately actuated commercially available PC. The display screen output is compressed and this signal is transmitted via radio to the pad.

Conversely, the user input is transferred back. A considerable hardware effort is required to decode the compressed signals. The transmission speed of available frequency bands is, however, too low for true video transmission, so that, for example, films on PCs or on the Internet are not relayable.

Additional and very powerful hardware is already thus required for the fulfillment of only a portion of the above-noted requirements.

It is the object of the invention to create a portable remote PC pad for personal computers that achieves maximum usage for minimal costs per household. In this connection, the deployed software is or should be compatible with the industry standard, should be exchangeable in a modular manner, and should be retrofittable. Furthermore, PC data should be further used in a seamless manner and, to avoid redundancy errors, should not be duplicated. PC knowledge should remain further usable so that there is not the need to introduce the same into new navigation systems.

In accordance with the invention, the challenge is solved through at least two component devices, whereby one component is connected with the PC and the other device is operable as a mobile pad in a circumference of 50 meters (in house) or 300 meters outside the house, whereby, between the devices, a communication occurs via radio in a wireless manner, comprising the audio-video transmission of the video output card of the PC to the touch screen-video-input of the pad, whereby all of the programs available on the PC and the screen output are viewable on the pad via the AV-channel.

It is contemplated that a PC system comprising a wireless audio-video transmission extent is encompassed in the invention. This invention makes possible the cost-favorable realization of portable full value Internet-access on a display with PC resolution without the deployment of expensive digital compression or de-compression technology.

The PC control is possible remotely via a keyboard and/or a mouse simulation. In this connection, a back channel comprised at least of a data radio link between the pad as a data transmitter and the PC as a data receiver is used. These data are processed via the PC interface such as, for example, RS 232, via the normal keyboard or mouse controls of the PC.

The dependent claims have advantageous further embodiments of the invention.

The portable remote PC pad can additionally comprise a microphone in the pad and an audio radio link from the pad in the role of an audio transmitter to the PC in a role as an audio receiver.

Furthermore, a signal mixer can additionally be provided which mixes the data between the pad and the PC on the audio channel and thereby renders superfluous a separate data radio link—namely, the transmitter and receiver radio link.

Furthermore, the inventive remote PC pad can additionally encompass a SCART jack or port that relays the video input of the touch screen and receives the video data from AV devices.

A further advantageous embodiment of the invention is comprised of an additional infrared transmitter on the pad. This is suitable in order to control a TV, a video recorder or a cellular telephone. The control signals are either transmitted in a separate radio link between the PC—that is, data via the infrared transmitter to the radio transmitter—and the pad—that is, as a data receiver or a transformer or mixed with the audio signal and decoded in the pad.

Moreover, a video back channel from the pad in the role of a video transmitter to the PC in the role of the video receiver can be provided. The video receiver is connected with the video input of the PC, such as, for example, the TV card. The video transmitter is connected with a Webcam that is optionally integratable on the pad or with the SCART jack or port of the pad.

A further embodiment of the portable remote PC pad is characterized via, additionally, an infrared receiver in the pad or in the PC box and additionally is comprised of either an “infrared into data” converter which uses an organic data radio link, or is connected with the data-audio converter, or a separate infrared transmitter transmitting via radio signals between the pad in the role of the sender and the PC in the role of the receiver.

In accordance with yet another embodiment of the inventive solution, all decoded and coded tasks are replaced within the PC box via software that runs on the PC. Data output and/or infrared output are, in this connection, already mixed within the PC via the audio output. In the same manner, the infrared and/or data signals in the audio input within the PC are decoded via software in order to not burden the hardware in the PC box.

Via this solution, a cost favorable and simple hardware is created. In this connection, a hardware structure available in a household is connected in, whereby the double creation of hardware is avoided. Additionally, the necessary hardware integrates in industry standards and as a consequence thereof makes possible a wide available device selection. Proprietary hardware components are reduced to a minimum in order to render usable for the user the rapid developments in the respective technology sectors.

The user can manipulate on the pad his or her customary menu guides and navigations and can provide on the pad additional standard software for his or her system. Via the possible integration of standard software, it is achieved that here, as well, a wide and rapid new development of improved solutions can be accessed.

The goal of modern Web-pads is, next to the core function of the mobile Internet access, the access to PC programs. The goals are, in particular, the savings of time via the anytime access of Internet uses and comfort such as, for example, the reading of an incoming fax or an incoming mail while, for example, in a bathtub.

In the following description, details of the following modern functions used by a user within a residence are described which can be accomplished without having to be located at the Internet PC:

1. Internet Access

1.1 Secure Home Banking Via TV and Remote Service

All four types of home banking should be supported:

per Internet access (per HBCI or PIN/TAN);

per Internet service provider authentication (T-online);

per KEY-diskette (HBCI);

per chip card.

1.2 Other Methods for Authentication

As well, digital signatures of the connection of fingerprint recognition or iris recognition and the use of the software associated therewith should be available on TV.

1.3 Illustration of All Internet Formats

While Web pads can, in accordance with the state of development and operating system as well as the stored software, show still only a subset of all formats, the inventive solution should be able to show all formats and elaborate all Internet functions such as, for example:

Reading/storage of cookies;

Secure-HTML;

DHDML-pages;

JAVA per JVM Java virtual machine such as, for example, for home banking usages and for participation on audio chats via use of a microphone;

Java script;

ftp; htp; http; mms; etc.:

Display of all audio and video formats (realaudio; Quick time-AVI; multi media streams; streaming video; MPEG2, MPEG4 etc.);

To ensure the correct further transmission of certain formats, the downloading and the installation of diverse additional software such as, for example, as plug-in software for the Internet browser must be possible.

1.4 Call up of Content such as Video-On Demand or Software

The call up of (and the payment for) the desired content from the Internet; transport as selected from the Internet per sterling (authenticity) or download (time-shifted) or via satellite.

1.5 Full E-mail Functionality with Central Contact and Data Processing

Disadvantageously, the E-mail functionality of known STBS or Web pads are constrained by the following limitations:

E-mail addresses cannot be centrally stored or cannot be further used.

News attachments go lost as a result of lack of storage space or cannot be opened as a result of the absence of reading software (Word; Acrobat Reader; Excel; Video Player; Audio Player).

News (mails and news) cannot be further used on household PC's without further adaptations.

These above-noted disadvantages are overcome via the herein-described solution.

2. Connection of Household Telephone Installations on the Mobile Receiver and the Telephone Function on the Display.

Telephone calls should be received via remote connections directly on the mobile pad (display of the calling number, properties/picture of the caller; most recent call; ground capability; the input of keywords for real time conversation; storage in additional installations in the event that a callback is desired).

3. Picture Telephony Capability with Receiver and Transmitter

The caller, along with a picture, should be shown on the TV in the living room. The actual picture should be transmittable via a Webcam to, as the occasion arises, the conversation partner. In this connection, available Internet chat/Net meeting software packets should be deployable.

4. Remote Control of, for example, TV and Video through the Internet

All of the devices connected to the system should be controllable via the Internet either in that direct control commands can be called up or in that control data sent in Internet packets in the system are changed or in that control data disposed in the Internet can be altered and the control instructions can be called up and processed by the next following choice in the system in the Internet.

5. Usage of DVD's and Video CD's and Audio CD's on the Pad

A DVD player device already available in the household, a CD player already available in the household, a CD burner already available in the household should be equally usable on the PC or on the pad, independent of where the user has installed such a device and without the necessity of creating a new connection.

6. Remote Usage of Available Hardware Via the Pad, also in the Event that Such is Installed on the PC

A text which can be viewed on the pad should be stored on a fixed storage medium or diskette as requested via remote service or should be capable of being printed without the necessity to make available or install an additional printer.

7. Usage of PC Playing Equipment or Internet Play on the Pad

On the one hand, the playing of play activities directly on the pad should be possible without the need to install a PC in the living room. On the other hand, a player on the pad can be used for playing a game against or with another player on the PC. In this connection, the player is connected with the pad.

8. Central Help Position for Personal Installation and Updating of Additional Software

The user should automatically receive software updates via Internet choices.

9. The PC Used in the Pad

The user should be able to access, from every location in the residence, the PC programs and have access to the data of his PC or the data of his Internet storage areas. This PC work should run in parallel to, for example, the use of the TV. Long PC processing jobs should remain viewable parallel to the viewing of TV programs. The exchange between TV outputs or, respectively, the parallel running on a screen should be supported via Window technology. As an option, the TV screen should not only display a program, but also display several programs in parallel. Also, the use of conventional 10 instruments (keyboard, mouse) should be available in a mobile capacity.

10. Full PC Functionality

Additionally, the use and service of external PC devices such as CD burners, DVD playing devices, CD players, TV cards, scanners, fax cards, modems, and printers should be available from any location in the residence without having to make possible the availability of additional hardware.

11. Control Via Speech Parallel to Menu Navigation

The user should have the possibility to use the conventional possibilities for speech control on the PC via speech recognition software in addition to pad navigation or, respectively, to navigation on the pad. In this connection, commercially available speech software should be used without the need for an adaptation to the hardware of a set-top-box.

12. Broadcast of Incoming News Items or Available Text

Text, mails, or menu requirements should be outputable via the audio output of the pad. In this connection, commercially available speech software is used without the need for an adaptation to the hardware of a set-top-box.

13. Interactive TV

In parallel, and in a combination to exactly that which the user receives for TV programs, the additional information should be immediately installed or should be accessible via remote service from an additional menu. Animation should be filtered in within the TV picture that is alternatively linked with Internet pages or is called up via additional programs. The control data of these services should be available ahead of time for live and real time such as, for example, via an Internet connection in the system.

14. Personal Information Center

In the personal structure of predetermined information, the information should be displayed each morning on the pad screen. The user should be able to print out and archive his personal morning paper via keystrokes. The information is, for example, available upon waking up. In the event that particularly relevant information (for example, reaching stock market limits) is found, the pad should be immediately activated. Additional immediately current data streams such as videotext or Internet services on the TV sender should be installed that can, as the occasion arises, also be searched via keywords.

15. Internet TV Transmitter Sources

The user should be able to choose the program sources independent of the technical storage locations or, respectively, the delivery approaches. Films or, alternatively, films delivered via cable or satellite over conventional broadcast means, should be receivable or, on the other hand, such films should be played via the Internet video sequences. The same counts as well for the installation of DVD's, video recorders, or video CD's.

The following components are considered as corresponding to the state of the art that is assumed as available for use of the contemplated system in the area of a household:

A PC or the possibility to install a PC in a workroom. The conventional programs are installed on this PC, such as email, Internet, text processing, and multi-media player. At the same time, the typical conventional hardware such as a printer, a monitor, and input devices such as a keyboard and mouse, are installed.

Even if a PC is not yet available, the inventive solution offers a monetary advantage relative to proprietary Web pads. Most often, the commercially available Web pads are more expensive as compared to a commercially produced standard PC, in that the hardware components are comparable but the web-pads are produced in lower quantities. At the same time, a Web pad is not useful for any other purpose in contrast to the production of a PC.

In the following, the availability of a PC is assumed.

On this PC, a so-called basis-box 200 is installed. This box, with the dimension of a cigarette box, comprises only relatively little standard hardware—namely, an AV sender and, optionally, an AV receiver.

The remote pad itself is comprised of a touch screen—that is, a keyboard and mouse simulation available for touch commands, an AV receiver, a microphone, and an audio sender, as well as optionally, an infrared sender and receiver. A video sender is optionally integratable together with a web cam.

The basis-box as well as the remote pad can send data via the combination thereof on the audio channel or separate sender in accordance with the respective price point and receiving, via filtering out of the audio channel or separate data receiver in accordance with the respective price point. The data can be control data or infrared commands.

As the fourth component of the system, a driver/software package is delivered therewith, the software comprising operating systems for the household PC.

These five basic component are already sufficient in a multiplicity of household configurations to fulfill the above-noted requirements.

All further components are commercially known PC add-ons that—to the extent not available—can be separately added on:

A TV card with the typical in- and output connections (input: antenna cable; satellite cable; S-VHS; output: S-VHS or composite video) and the typical features; AVI-recording; MPEG2 recording.

A graphics card with TV output (most typically S-VHS or composite video) or, to the extent the user wishes to use his graphics card without TV output, a VGA2PAL or, respectively, VGA2NTSC converter, which is connected between the PC and PC base box.

Via the modular disassembly, the user need only acquire those components that he does not yet possess. In this manner, the cost-minimising solution for the above-noted requirements is ensured. The duplicate acquisition of hardware, within a household, is not required. The total system is predominantly comprised of standard components, so that technical further development and long-time price-favorable performance is guaranteed.

The concepts underlying the invention are described in the hereinafter following description with reference to an embodiment which is shown in the drawings. It is shown:

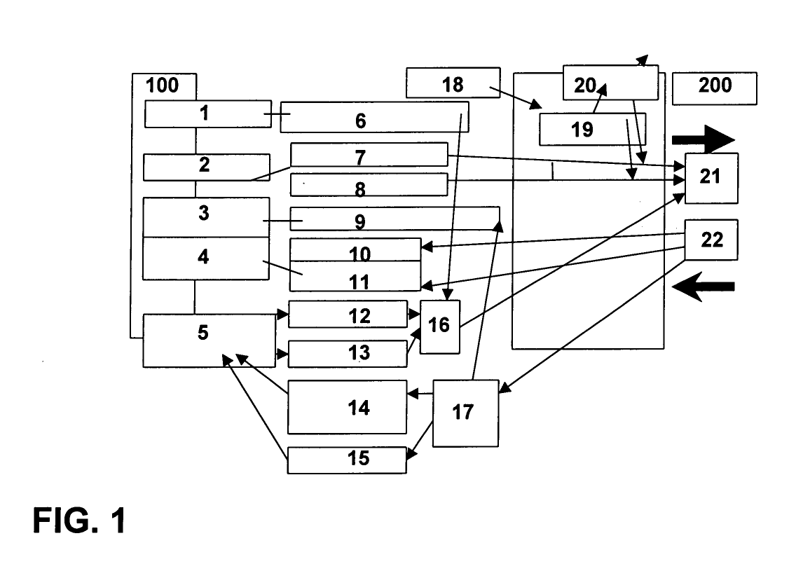

FIG. 1: A schematic illustration of the audio video signal guide of a PC basis-box and

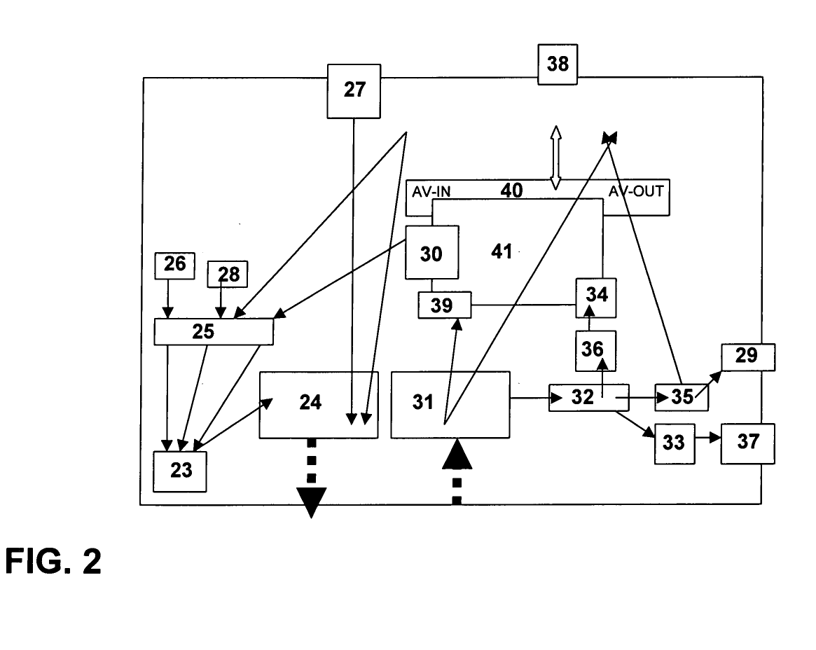

FIG. 2: A schematic illustration of the portable remote pad.

As can be seen in FIG. 1, the basis-box 200 makes possible the transmission of audio and video signals from PC 100 or, optionally, from other sources such as a satellite receiver, digital TV card, DVD player, and so forth, to the pad or, optionally via a SCART plug to other AV drops such as a video recorder, digital recorder and so forth, and transmission in the reverse direction. Optionally, the installation of a converter is possible.

In particular still to be mentioned is the connection of an IR-learn-diode in FIG. 2. Optional IR sending signals can be stored with help of this diode, by which the UE devices in the living room can be controlled, such as the TV, video, and so forth.

It is to be understood that the solution can, instead of an external basis-box, also be realized as a PC plug-in card.

In total, the PC basis-box component list is comprised of the following components:

A board & a housing and mounting equipment;

4 video plugs (2*S-VHS; 2*composite);

2 audio cables (stereo, cable, jack plug, and doubler);

AV (audio/video) transmitter, optionally, an AV receiver;

Coding elements for data transmitted via audio and, optionally, a decoder for audio and data;

External linking component;

Data connection: USB adapter cable, or Com2 cable or printer port cable.

In total, the following components are necessary in the TV center box:

One up to a maximum of three switches controllable via 12C;

Optionally, a remote control (with the same IR code as a standard TV card);

IR performance sending diodes;

1 Pic controller for data communication;

External linking element;

2 SCART jack or ports, 1 SCART plug;

IR receiver and amplifier;

Built-in microphone;

Microphone switch with an on/off switch including, optionally, LED; the switches are necessary in order to be able to switch the microphone output to the TV audio output, in that (to the extent no mixing operation is desired, as is generally the case with video dubbing) the TV is switched to mute;

12.5 switch voltage generator.

The Web pad itself possesses no CPU, no storage, no optical disk, and no PC-similar hardware. It is comprised of inexpensive AV components:

An AV receiver and, optionally, an AV transmitter (for example, for web cams or connection of a video recorder on an AV port or interface);

An AV plug (AV-in and AV-out);

A touch screen with FBAS input (optionally, VGA input with converter or transmission of VGA in the AV relay);

Optional IR sender and receiver;

A data sender and, optionally, a receiver or a coding/decoding element for handling data of the audio stream to thereby extract such or intervene thereat.

The above-noted basic disadvantages of PC-based pads are overcome via the arrangement and components of the contemplated solution.

On a commercially available PC, the remote PC pad is connected with the usual 10 ports, preferably on the RS232 interface but, as well, USB or bidirectional LPT ports would be possible. In this manner, the video and audio input and output to the PC basis-box are connected, as is shown in FIG. 1. Insofar as the graphics card is not provided with a TV out output, a VGA2PAL converter module is inserted in the PC base box and the VGA output is connected with the VGA cable of the PC base box. The monitor is connected with the VGA out output of the converter.

The signal path of the built-in microphone of the Web pad goes directly to the microphone input of the PC.

In principle, even a camera would be connectable, which as well, can be switched on via the video output signal of the optionally provided AV sender. In this manner, bi-directional picture telephony would be possible. Without a separate camera, mono-directional picture telephony is, in any event, configurable. The pad owner sees the caller who has a web cam.

A joystick would preferably be connected to the Web pad. The control commands would be converted as well as the mouse commands, or the integrated mouse simulation of a touch screen.

Via the installation of a TV card in the PC, numerous advantages of a TV card are available to the pad user. Mixed modes with PC/Internet, installation of texts, picture in picture modes; multi-channel previews (for example, 16 senders simultaneously available on the screen); receipt of programs on the optical disk; storage of pictures. In particular, now EPGs can be put into use that can be activated via the Internet and that can actively support the user directly in the choice of program: self-standing exchange of TV programs through the PC software, filtering out of undesired transmitted content (advertisement or children protection); display on the video recorder or optical disk; branching in of incoming mails or telephone text; interactive TV via the over-layering of menu top surfaces with the TV picture; any time available exchange from the PC desktop and the customary control via mouse and keyboard, etc. That means, computer-supported TV without having to sit at a computer.

The contemplated solution makes possible, however, not only the coordination of this “personal TV” virtual channel but rather, as well, the control of end devices in the living room via infrared. The corresponding IR sequence is taught one time to the PC via the learn diode of the pad and is stored on the optical disk. At the same time, the sequence in which these signals are to be sent to the end devices is configured so that, for example, the TV changes into a two-channel mode. Thereafter, the PC can control, via the pad, numerous devices via the sending out of IR commands.

Also, child protection requirements can be realized as the PC can prevent the display of undesired transmissions and, via EPG, can even withdraw stop such transmissions.

Components List:

100 personal computer (PC)

200 PC basis box

1 sound card (audio out stereo audio plug)

2 graphics card (S-VHS TV out or Composite out)

3 sound card (stereo-line in)

4 TV card (S-VHS in or composite in)

5 Data input/output (RS232 or USB or parallel port and so forth)

6 Stereo-audio jack plug

7 S-VHS Hosiden plug

8 Composite video plug

9 Stereo audio jack plug

10 S-VHS Hosiden plug

11 Composite video plug

12 Infrared signals

13 Control data

14 Mouse/touch command/data

15 Infrared Signals

16 Audio Encoder

17 Audio Decoder

18 VGA plug

19 VGA TV

20 VGA jack or port

21 AV sender

22 AV receiver

23 Audio data encoder

24 AV sender (AUDIO VIDEO)

25 Infrared (Audio, data)

26 Infrared receiver

27 Webcam

28 microphone

29 loudspeaker and headphone jack

30 data output (mouse/touchscreen)

31 AV receiver (audio (mix) video)

32 data audio decoder

33 infrared

34 data input (brightness and so forth)

35 pure audio

36 data

37 infrared sender

38 connectable to TV/video/sat receiver

39 video in

40 SCART plug

41 touch screen

1. A portable remote PC pad for a PC, characterized by at least two component devices, whereby one component is connected with a PC and the other device is operable as a mobile pad in a circumference of 50 meters (in house) or 300 meters outside the house, whereby, between the devices, a communication occurs via radio in a wireless manner, comprising the audio-video transmission of the video output card of the PC to the touch screen-video-input of the pad, whereby all of the programs available on the PC and the screen output are viewable on the pad via the AV-channel.

2. A portable remote PC pad according to claim 1, characterized by, in addition, a microphone (28) in the pad and an audio radio relay from the pad as the sender to the PC as the audio receiver.

3. A portable remote PC pad according to claim 1 or 2, characterized by, in addition, a signal mixer (23).

4. A portable remote PC pad according to one of claims 1 through 3, characterized by, in addition, a SCART jack or port.

5. A portable remote PC pad according to one of claims 1 through 4, characterized by, in addition, an infrared sender (37) on the pad.

6. A portable remote PC pad according to one of claims 1 through 5, characterized by, in addition, a video back channel from the pad as a video sender to the PC as a video receiver.

7. A portable remote PC pad according to one of claims 1 through 6, characterized by, in addition, an infrared receiver (26) in the pad or in the PC box and additionally comprising either an “infrared into data” converter that uses an organic data radio link, or that is connected with the data-audio converter, or a separate infrared transmitter transmitting via radio signals between the pad in the role of the sender and the PC in the role of the receiver.

8. A portable remote PC pad according to one of claims 1 through 7, characterized by a substitution of all decoding and coding tasks within the PC box via software that runs on the PC.
